(19) United States
(12) Patent Application Publication
(10) Pub. No.: US 2024/0393779 A1
(43) Pub. Date: Nov. 28, 2024

(54) INTERACTIVE FACILITY MONITORING ALERT MESSAGING

(71) Applicant: AVTECH Software, Warren, RI (US)

(72) Inventors: Andrew Embry, Warren, RI (US); Richard Grundy, Warren, RI (US); Dell Sala, Warren, RI (US); Allie Wojtanowski, Warren, RI (US)

(21) Appl. No.: 18/201,994

(22) Filed: May 25, 2023

(51) Int. Cl. G05B 23/02; G05B 19/418

(52) U.S. Cl. CPC G05B 23/027; G05B 19/418; G05B 23/0272

(57) ABSTRACT

A facility monitoring system, device and application receives and interprets readings from multiple sensors for determining a condition, alert or alarm triggered at the facility, and initiates appropriate notifications and/or responses. Low-cost sensors detect or receive a sensed parameter pertaining to a condition in a physical facility space, such as temperature, moisture, electric failure or portal/door state. Sensor feedback transmitted and received at a remote facility manager or application is reported via a user accessible GUI (Graphical User Interface). The facility manager commences remedial action in response to an anomalous sensor state or reading, which includes notification of responsive entities for correcting or mitigating the triggering condition. Notification includes commencing a communication thread with responsive entities including a facility manager having a natural language interface and vocabulary responsive to the communication thread for related queries, and proactive logic for generating likely causes or measures for remediation.

### BACKGROUND

Commercial enterprises deploy facilities for housing workspace, inventory (warehouses), infrastructure, logistics (trucks/garages) and other elements of a physical plant. Modern businesses often employ substantial IT (information technology) equipment, including storage devices, networking elements and connections, computing devices, and production hardware such as robotics, 3-D printers/extruders, and other specialized devices depending on electronics and processor control. Such equipment often represents a substantial investment. Physical facilities and in particular, electronic systems, are susceptible to a breach, failure or infiltration to the physical facility that affects the integrity and operation of the facility. In addition to the threat of trespass and vandalism by bad actors, equipment failure and natural or catastrophic occurrences, such as extreme weather, flooding, cold, and even incursions related to human error such as doors left ajar can trigger anomalies that compromise the facility and contents therein.

### SUMMARY

A facility monitoring system, device and application receives and interprets readings from multiple sensors for determining a condition, alert or alarm triggered at the facility, and initiates appropriate notifications and/or responses. Low-cost sensors detect or receive a sensed parameter pertaining to a condition in a physical facility space, such as temperature, moisture, electric failure or portal/door state. Sensor feedback transmitted and received at a remote facility manager or application is reported via a user accessible GUI (Graphical User Interface). The facility manager commences remedial action in response to an anomalous sensor state or reading, which includes notification of responsive entities for correcting or mitigating the triggering condition. Notification includes commencing a communication thread with responsive entities including a facility manager having a natural language interface and vocabulary responsive to the communication thread for related queries, and proactive logic for generating likely causes or measures for remediation.

Configurations herein are based, in part, on the observation that monitored facilities may encounter detected conditions or alerts during off-hours when the facility is unoccupied. Unfortunately, conventional approaches to facility management suffer from the shortcoming that additional diagnostic or supporting information to complement and clarify the alert may require cumbersome queries and/or GUI traversals for determining related information. Information gathering, communication with other relevant personnel or employees, and possibly a site visit and inspection may be pursued to asses the severity and urgency of the condition attested to by the alert.

Accordingly, configurations herein substantially overcome the shortcomings of conventional approaches by commencing a conversation among entities based on a relevance to the alert. The conversation may take the form of an interactive device exchange or communication thread, where the facility manager initiating the alert invokes a natural language interface for messages passed on the communication thread. The messages take the form of interactive textual or verbal transmissions to a number of participants in the communication thread. Participants receive the messages on an interactive device such as a cellphone, smartphone or laptop, and the facility manager interprets the message based on a vocabulary of predetermined tasks or related inquires. Graphical depictions or photographs may also be exchanged via the communication thread. The facility manager may suggest or inject related information based on a probability of interdependence between related sensors, locations or causes in the facility.

In further detail, in a facility management environment having a plurality of sensors disposed around a facility, where each sensor is in communication with a facility manager for reporting sensed conditions, a method for resolving a sensed anomaly in the facility includes receiving an alert indicative of an anomaly in the facility based on a sensor deployed in the facility. The facility manager identifies one or more responsible entities, such that each responsible entity is associated with an interactive device operable for communication with others of the responsible entities, typically a mobile device or smartphone. The facility manager establishes a communication thread based on the received alert, where the communication thread is responsive to participants associated with the received alert. The participants in the communication thread include the responsible entities and the facility manager. When a communication is received from any of the participants in the communication thread, the communication is delivered to the interactive device associated with each of the respective participants.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a monitored facility environment suitable for use with configurations herein;

FIG. 2 shows a communication thread in response to an alert in the environment of FIG. 1;

FIG. 3 shows an interactive device GUI (Graphical User Interface) transacting the communication thread of FIG. 2;

FIG. 4 shows database entities concerned with an alert response; and

FIG. 5 shows a flowchart of processing activity from a conversation initiated in response to an alert.

### DETAILED DESCRIPTION

Configurations below depict an example implementation of a facility and facility infrastructure suitable for use with configurations herein. Alternate facility arrangements may be employed, in accordance with the principals and advantages of the disclosed approach.

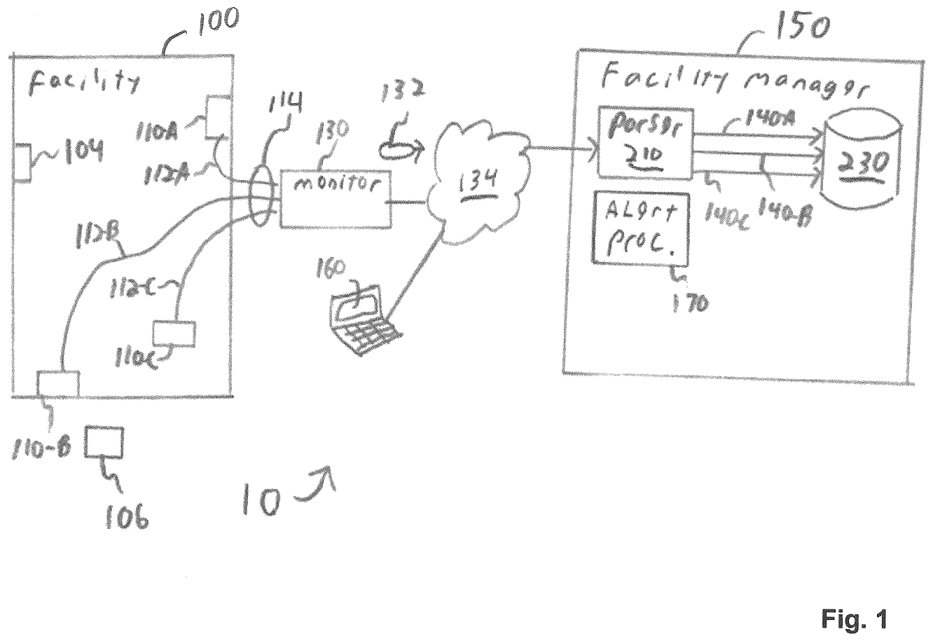

FIG. 1 is a context diagram of a monitored facility environment suitable for use with configurations herein. A facility 100 in the environment 10 may be any suitable enclosed structure such as offices, warehouses, transportation sites, apartments and residential units, and home dwellings. Often the facility 100 is characterized by common ownership entity such as a corporation. At least portions of the facility 100 include machine rooms having computing hardware and related network appliances, with different and/or more specific monitoring and sensing needs than inhabitable conditioned spaces. The facility 100 also often has a well-defined and continuous perimeter with discreet entry and exit portals or passages such as doors and windows.

The facility environment 10 deploys various sensors 110-A . . . 110-C (110 generally) such as temperature, humidity, portal closure/entry, ventilation flow, electric/current flow, motion or any other sensor operable for responsiveness to an environmental or facility infrastructure condition. In a particular configuration, the sensors may be those operable in conjunction with the Room Alert line of products, marketed commercially by AVTECH Software of Warren, Rhode Island.

In the example facility management environment 10, a plurality of sensors are deployed around a facility 100, such that each sensor is in communication with a facility manager 150 for reporting sensed conditions, A typical monitoring environment includes the monitored facility (facility) 100, an on-site monitor 130 with connections to the sensors 110 in the facility 100, and a facility manager 150 in remote communication with the facility 100, as well as other facilities. In the example facility 100 of FIG. 1, the sensors include a door 110-A, ambient temperature 110-B and HVAC outflow temperature 110-C (110 generally). Sensors 110 may also monitor other aspect, such as ventilation fans 104, HVAC equipment 106, and other equipment and fixtures, and a typically facility may have many more sensors than the presented example. In operation, the onsite monitor 130 periodically receives a reading from each sensor 110 via a respective local connection 112-A . . . 112-C (112 generally). The monitor 130 transmits a message 132 for each reading 112 via a channel 140-A . . . 140-D (140 generally) assigned to a corresponding sensor 110. Any number of sensor readings may be included in the message 132, depending on a polling rate of the sensor 110 and a transmission rate from the monitor 130. The facility manager 150 is configured to launch and execute applications for receiving parameter values from each of the channels 140, such as application programs from AVTECH as discussed above. The facility manager 150 also has a Graphical User Interface (GUI) application 160 conversant with the network 134 for remote user interaction via a mobile device.

Upon message 132 arrival at the facility manager 150, a message parser 210 parses the message 132 into values with timestamps and determines channels 140-A, 140-B and 140-C (140 generally) corresponding to the respective sensor 110. Since the sensors 110 may have different cycles for reading values, the message 132 may have any number of values corresponding to the channels 140. An identifier in the message denotes the sensor and channel, along with a respective received value for the sensor 110.

The facility monitoring infrastructure of FIG. 1 provides a comprehensive monitoring and reporting system covering a facility 100 for reporting anomalies and any deviation from sensed occurrences or conditions falling outside an expected range. The individual sensor configuration, range of expected values and values deemed to be deviant are configured by the control application GUI 160. The individual sensors may include any suitable detection medium, such as thermistor, magnetic, optical, infrared (IR), piezoelectric, EMF (electromagnetic field) and others. The sensors 110 may measure any suitable parameter in the facility, such as temperature, humidity, carbon monoxide or other gas, fire, position (i.e. doors/windows open/closed), vibration, electrical flow, moisture or other condition or detectable occurrence. Further details on the facility monitoring infrastructure may be found in U.S. Pat. No. 10,678,611, filed Jul. 18, 2018, entitled “FACILITY MONITORING SENSOR,” assigned to the assignee of the present application and incorporated herein by reference in entirety.

An alert processor 170 generates alerts based on incoming messages from the facility. In the example configuration, the alert processor 170 establishes or identifies a range of values for each sensor 110, and designates, for each sensor, values in the range deemed to define a current anomaly. Values may be scalar, Boolean or integer; in the case of a door or window, only one of two values is received. Other parameters, such as temperature, may represent a continuum over a range. In operation, periodically polling of by the monitor 130 generates the message 132 including the sensed value for each of the sensors for determining an existence of the anomaly. The alert processor 170 compares the sensed values from the message 132 to the predetermined thresholds or deviant readings that indicate an anomaly, and generates a corresponding alert if the sensed values are outside an expected range or set of values indicative of normal operation.

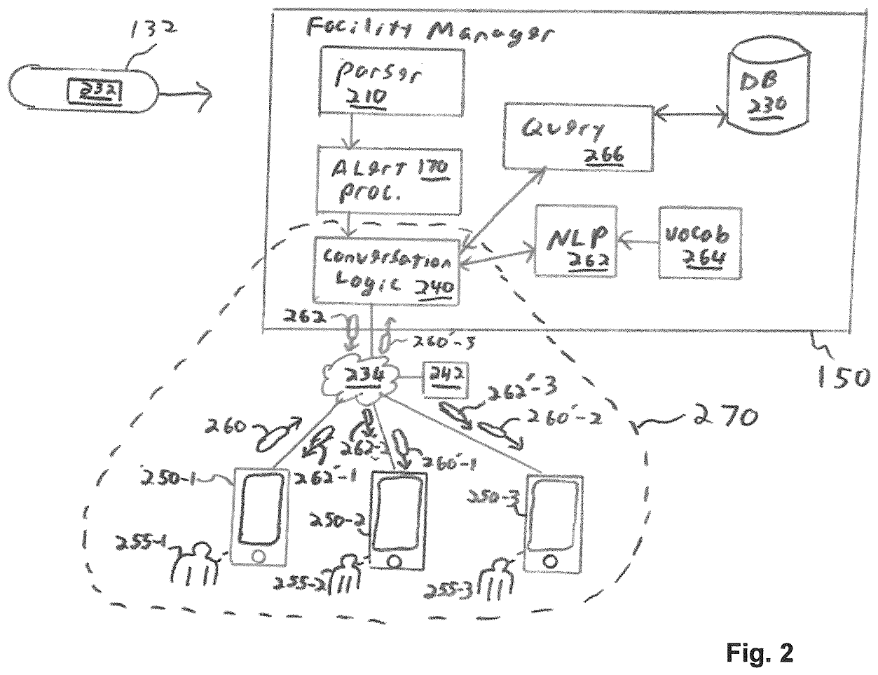

FIG. 2 shows a communication thread in response to an alert in the environment of FIG. 1. Referring to FIGS. 1 and 2, when an alert 232 indicates a need for resolving a sensed anomaly in the facility, the alert processor 170 identifies one or more responsible entities 255-1 . . . 255-3 (255 generally), where each responsible entity is associated with a respective interactive device 250-1 . . . 250-3 (250 generally) operable for communication with others of the responsible entities 255. In a general scenario, the responsible entity 255 is an employee tasked with facility oversight, possibly in conjunction with an “on-call” revolving work schedule. Other responsible entities might include the employee's supervisor, and/or a role specific person, such as an HVAC (heating/ventilation/air conditioning) person in the case of a temperature alert, or if the alert references a machine room, a network manager. Each responsible entity 255 has an interactive device capable of message exchange, typically a smartphone or cell phone within the possession of the employee. Other suitable devices include a laptop or desktop, tablet, or any suitable device capable of text messaging, audio and video transmission.

After the alert processor 170 reports the alert 232 to the responsible entities 255, the conversation logic 240 commences the communication thread concurrently with or after reporting the alert 232. The communication thread establishes an interactive messaging context among the group of participants 270. In addition to transmitting the alert to the respective responsible entities 255, a conversation logic 240 module also receives the alert 232. The conversation logic 240 establishes a communication thread based on the received alert, where the communication thread is responsive to participants 270 associated with the received alert 232. The group of participants 270 includes at least the one or more responsible entities 255, and the facility manager 150 itself, as directed by the conversation logic 240. This defines at least a messaging environment where messages sent from each participant are visible to the others. A speech to text translation may be involved to generate printable text from a verbal statement. Transmission of still photos and video may also be communicated among the participants. The communication thread is supported by a network messaging facility 242 for transport of conversation messages among the recipients by a public access network 234 such as the Internet. The network messaging facility may encompass some or all of SMS (Short Message Service) and related derivatives, IP (Internet Protocol) and other related transport mechanisms that underlie text messaging and social media applications.

Once established, the communication thread may be employed for receiving a communication 260 from one of a plurality of the participants 270, and delivering, via the communication thread, the communication 260′-1 . . . 260′-3 to the interactive device 250 associated with the each of the respective participants. Still further, as the conversation logic 140 receives the communication 260′-3, it can parse readable text in the communication, determine, via keywords or natural language recognition of a query or interrogative directed at the facility manager 150. In response, the conversation logic 240 generates a response communication 262 for delivery 262′-1 . . . 262′-3 to each of the other participants 270, via devices 250.

Conventional approaches using remote site monitoring techniques would require one of the participants to engage a VPN (Virtual Private Network), remote desktop, or other remote access medium to a database for generating a query, receiving the query, and then manually reproducing query results for each of an intended recipient. In contrast, the disclosed approach establishes the communication thread to include the conversation logic 240 of the facility manager 150 as a party to the communication thread, and to identify messages 260 directed to the facility manager 150, generate a corresponding query, execute the query, and reply with a response 262 message. For example, one of the responsible parties may want to know what other alerts may have recently occurred, or if any other sensors are experiencing values near an alert threshold.

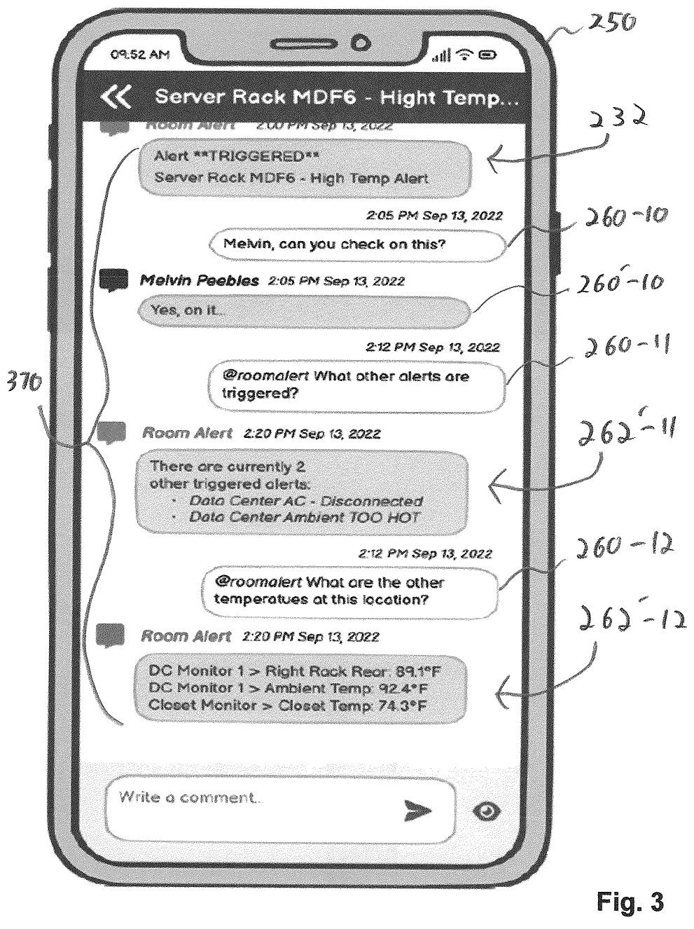

FIG. 3 shows a device GUI (Graphical User Interface) transacting the communication thread of FIG. 2. Referring to FIGS. 1-3, each responsible entity 255 has an interactive device 250 such as a smartphone. The alert processor 170 sends an alert 232 in the form of a text message which appears as a first message in the communication thread 370 among the participants 270, including the conversation logic 240. The communication thread 370 defines an interactive messaging exchange between each participant of a plurality of the participants 270, and may include sending a communication from an initiating participant of the participants. A communication 260-10 is sent via the device 250 to another responsible party. The communication 260-10 evokes a response communication 260′-10. Next, a communication 260-11 is sent, directed to the facility manager 150, optionally with the username/prefix “@roomalert.” The sent communication 260-11 is received at each of the other participants of the plurality of participants, including the conversation logic 240. The sent communication includes at least one of a narrative and a graphical component, such that the narrative component may be rendered on the interactive device of the participant visually or audibly. As with text messages, keyed in text is a viable representation, however verbal recognition and text-to-speech augmentation may also apply.

The communication 260-11 is interpreted by the conversation logic 240 as a query, and the conversation logic 240 invokes the query interface 266 for generating a response. The response 262′-11 is received on the interactive device 250, and prompts a second query in a communication 260-12, inquiring about other temperatures at the facility 100. The conversation logic 240 generates a second query, and generates the corresponding response communication 262′-12.

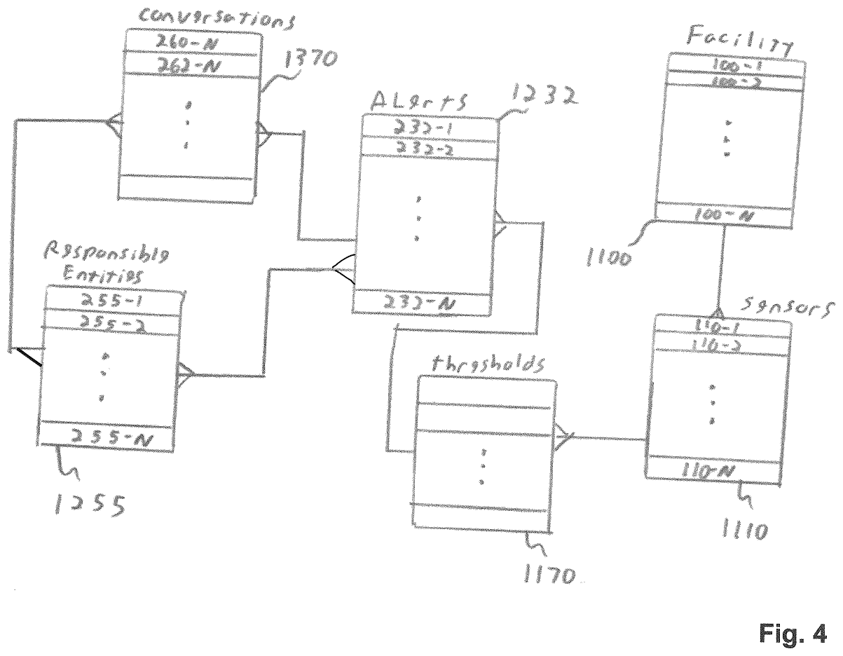

FIG. 4 shows database entities concerned with an alert response. Referring to FIGS. 1-4, the different entities and relations invoked in an alert response and ensuing communication thread are shown. A sensor table 1110 stores information about deployed sensors, their sensing domain and type of data sensed. Each sensor belongs to a facility in table 1100, in which a facility is likely to have many sensors. A sensor threshold table 1170 stores one or more threshold values for each sensor. The threshold table 1170 may be characterized as rules which indicate when a sensor is experiencing a deviant condition, including multiple possible sensor values (entries) if applicable. Rules for interpreting incoming sensor messages 132 may involve more complex relationships, as outlined in the related application cited above.

Alert table 1232 stores the computed alert entries resulting from the alert processor. When an alert is triggered, an entry in the alert table 1232 points to one of more of the responsible entities 255 in table 1255. This table associates, for each sensor and/or alert type, at least one responsible entity 255 for an anomaly detected at the respective sensor. The responsible entity table 1255 stores contact information including email, text message and phone No. for identifying and accessing the interactive device 250 of the responsible entity 255. In operation, when the alert processor 170 determines an occurrence of an alert, the type of the alert is used to identify the interactive device 250 associated with each participant 270, and commence the communication thread 370 from a network identifier of a telecommunications network accessible to each of the interactive devices, such as a text message identifier.

A thread table 1370 identifies the communication threads based on the responsible entities and the alert that commenced the communication thread 370. While the communication thread 370 commences with the responsible entities 255 based on the alert, the conversation logic 240 may receive a request to add a new participant to the established communication thread, and add the new participant to a plurality of participants 270 in the established communication thread 370.

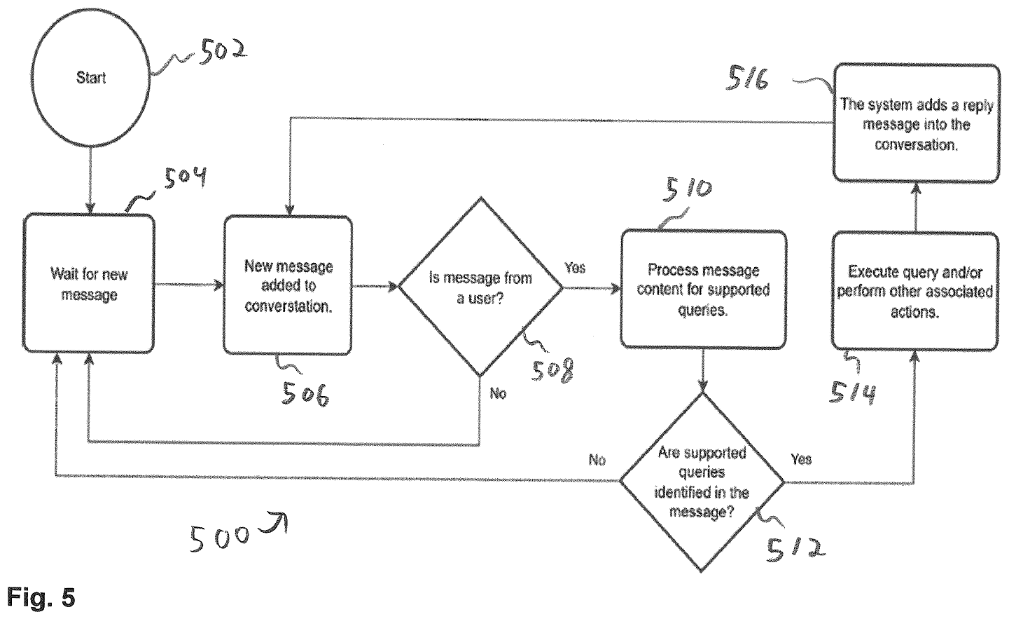

FIG. 5 shows a flowchart 500 of processing activity from a conversation initiated in response to an alert. Referring to FIGS. 1-5, at step 502, the conversation logic 240 initiates a conversation 502 based on the initial set of responsible entities 255 associated with the triggering alert 232. After the responsible entities are notified of the alert 232, the conversation logic 240 waits for a new communication 260, such as a text message from an interactive device 250.as shown at step 504. At step 506, a new communication 260 is received from a participant. A check is performed, at step 508, to determine if the message is from a responsible entity 255 corresponding to a human user. This check branches control to step 504 to wait for a new user message if the previous message was a reply to a previous query and initiated by the conversation logic 240.

The conversation logic 240 recognizes the received communication as directed to the facility manager, as depicted at step 510. A user may explicitly direct a communication 262 by calling out a recipient, i.e. @<recipient>, as described above. Additionally or alternatively, the conversation logic 240 may parse the received communication 260 for identification of keywords, and recognize keywords forming a query directed to the facility manager 150, rather than another participant 270. It should be noted that the conversation logic 240 resides in the facility manager 150 for performing the handling of incoming communications 260 in the communications thread 370.

Expected keywords and phrases are stored in a vocabulary of recognized verbiage. An example vocabulary/query set is shown in Table I. The keywords may also include phrases recognizable by a Natural Language Processing (NLP) module at the facility manager 150.

TABLE I

What is the current reading?
When was the alert triggered?
What is the trigger value of the alert?
What is the clear value of the alert?
How can this alert be cleared?
When did the alert clear?
How long has the alert been triggered?
What other alerts are triggered?
What other alerts are close to being triggered?
What other alerts are set to the same threshold?
What other [sensor type] are in the same location?
What other sensors are in the same location?
What is the average [sensor type] reading at this location?
What sensors have similar readings?
When was the last time this alert was triggered?
How many times was this alert triggered since [time]?
Where is this sensor located?
Who is talking about this event?
Who is on site?
Who is closest to the alert site?
Who has been notified of the current alert event?
Who is following this conversation?
What is the average [sensor type] reading at this location?
What were the readings since [time]?
When was this alert created?
Who was the last to modify this alert?
Send a reminder in [time interval].
Email [email address] about this.
Run [action name]

A check is performed, as depicted at step 512, to determine if a recognized query is found in the incoming message 260. If so, the conversation logic 240 generates a response communication 262 based on the received communication 260, as depicted at step 514. This may include invoking the query engine 266 to perform the query based on data gathered from the plurality of sensors or other data available in the facility manager database 230. The conversation logic 240 generates the response 262 based on the gathered data, and delivers, via the communication thread, 370 the generated response 262 to the interactive device associated with the each of the respective participants 270, as depicted at step 516.

Alternatively, extensions beyond the predetermined queries and vocabulary outlined in Table I may be pursued. The conference manager may train a model of phrases and/or keywords receivable by the facility manager, and compute a candidate query from applying the keywords to the model. The model is used to generate a probability that the computed candidate query corresponds to the communication, and employ the candidate query for performing the query if the probability is sufficiently high.

For example, the conversation logic 240 may commence or augment the conversation by proactively identifying one or more related sensors to the sensor from which the alert was received, and generate, by the facility manager, a response including data received from the related sensors. The conversation logic 240 then delivers, via the communication thread 370, the generated response 262 to the interactive device 250 associated with each of the respective participants 270.

Those skilled in the art should readily appreciate that electronic logic and instructions as disclosed herein are open to implementation in many forms, including but not limited to a) information permanently stored on non-writeable storage media such as ROM devices, b) information alterably stored on writeable non-transitory storage media such as floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. In a facility management environment having a plurality of sensors disposed around a facility, each sensor in communication with a facility manager for reporting sensed conditions, a method for resolving a sensed anomaly in the facility, comprising:
receiving an alert from a sensor, the alert indicative of an anomaly in the facility;
identifying one or more responsible entities, each responsible entity associated with an interactive device operable for communication with others of the responsible entities;
establishing a communication thread based on the received alert, the communication thread responsive to participants associated with the received alert, the participants including at least the one or more responsible entities and the facility manager;
receiving a communication from one of a plurality of the participants; and
delivering, via the communication thread, the communication to the interactive device associated with each of the respective participants.

2. The method of claim 1 further comprising:
reporting the alert to at least one of the responsible entities; and
commencing the communication thread after reporting the alert.

3. The method of claim 1 wherein the communication thread defines an interactive messaging exchange between each participant of a plurality of the participants, further comprising:
sending a communication from an initiating participant of the participants; and
receiving the sent communication at each of the other participants of the plurality of participants,
the sent communication including at least one of a narrative and a graphical component, the narrative component rendered on the interactive device of the participant visually or audibly.

4. The method of claim 1 further comprising:
identifying the interactive device associated with each participant; and
commencing the communication thread from a network identifier of a telecommunications network accessible to each of the interactive devices.

5. The method of claim 1 further comprising:
recognizing the received communication as directed to the facility manager; and
generating a response based on the received communication; and
delivering, via the communication thread, the generated response to the interactive device associated with each of the respective participants.

6. The method of claim 1 further comprising:
parsing the received communication for identification of keywords;
recognizing keywords forming a query directed to the facility manager;
performing the query based on data gathered from the plurality of sensors;
generating a response based on the gathered data; and
delivering, via the communication thread, the generated response to the interactive device associated with the each of the respective participants.

7. The method of claim 6 wherein the keywords include phrases recognizable by a Natural Language Processing (NLP) module at the facility manager.

8. The method of claim 7 further comprising:
storing a repository of NLP phrases recognizable by the facility manager; and
recognizing the keywords based on a correspondence to the repository.

9. The method of claim 7 further comprising:
training a model of phrases receivable by the facility manager;
computing a candidate query from applying the keywords to the model;
generating a probability that the computed candidate query corresponds to the communication; and
employing the candidate query for performing the query.

10. The method of claim 1 further comprising:
establishing a range of values for each sensor of the plurality of sensors;
designating, for each sensor, values in the range deemed to define a current anomaly; and
periodically polling each of the sensors for determining an existence of the anomaly.

11. The method of claim 1 further comprising:
associating, for each sensor, at least one responsible entity;
determining the responsible entity associated with the sensor from which the alert was received;
receiving a request to add a new participant to the established communication thread; and
adding the new participant to a plurality of participants in the established communication thread.

12. The method of claim 1 further comprising:
identifying one or more related sensors to the sensor from this the alert was received;
generating, by the facility manager, a response including data received from the related sensors; and
delivering, via the communication thread, the generated response to the interactive device associated with the each of the respective participants.

13. A facility manager device for gathering and analyzing data from sensors distributed around a facility for detection of ambient conditions, comprising:
a network interface to one or more remote facilities configured to receive an alert from a sensor, the alert indicative of an anomaly in a facility;
an alert processor configured to identify one or more responsible entities, each responsible entity associated with an interactive device operable for communication with others of the responsible entities;
conversation logic for establishing a communication thread based on the received alert, the communication thread responsive to participants associated with the received alert, the participants including at least the one or more responsible entities and the facility manager;
the communication thread configured to receive a communication from one of a plurality of the participants, and delivering, via the communication thread, the communication to the interactive device associated with the each of the respective participants.

14. The device of claim 13, wherein the facility manager is operable to:
report the alert to at least one of the responsible entities; and
commence the communication thread after reporting the alert.

15. The device of claim 13 wherein the communication thread defines an interactive messaging exchange between each participant of a plurality of the participants, the communication thread configured to:
send a communication from an initiating participant of the participants; and
receive the sent communication at each of the other participants of the plurality of participants,
the sent communication including at least one of a narrative and a graphical component, the narrative component rendered on the interactive device of the participant visually or audibly.

16. The device of claim 13, wherein the conversation logic is configured to:
identify the interactive device associated with each participant; and
commence the communication thread from a network identifier of a telecommunications network accessible to each of the interactive devices.

17. The device of claim 13, further comprising:
a vocabulary for recognizing the received communication as directed to the facility manager, the conversation logic further configured to generate a response based on the received communication; and
deliver, via the communication thread, the generated response to the interactive device associated with each of the respective participants.

18. The device of claim 13 further comprising:
conversation logic to parse the received communication for identification of keywords;
a vocabulary to recognize keywords forming a query directed to the facility manager;
a query manager to perform the query based on data gathered from the plurality of sensors and generate a response based on the gathered data,
the communication thread configured to deliver the generated response to the interactive device associated with the each of the respective participants.

19. The device of claim 18 further comprising a Natural Language Processing (NLP) module at the facility manager for recognition of keywords.

20. A computer program embodying program code on a computer readable non-transitory medium that, when executed by a processor, performs steps for implementing a method for, in a facility management environment having a plurality of sensors disposed around a facility, each sensor in communication with a facility manager for reporting sensed conditions, resolving a sensed anomaly in the facility, the method comprising:
receiving an alert from a sensor, the alert indicative of an anomaly in the facility;
identifying one or more responsible entities, each responsible entity associated with an interactive device operable for communication with others of the responsible entities;
establishing a communication thread based on the received alert, the communication thread responsive to participants associated with the received alert, the participants including at least the one or more responsible entities and the facility manager;
receiving a communication from one of a plurality of the participants; and
delivering, via the communication thread, the communication to the interactive device associated with the each of the respective participants.
